(19) United States
(12) Patent Application Publication
(10) Pub. No.: US 2024/0234715 A9
(43) Pub. Date: Jul. 11, 2024

(54) PROCESS FOR MANUFACTURING A SOLID-STATE MICROBATTERY AND CORRESPONDING MICROBATTERY

(71) Applicant: Commissariat à l'Energie Atomique et aux Energies Alternatives, Paris (FR)

(72) Inventors: Jean-Philippe COLONNA, Grenoble cedex 09 (FR); Sami OUKASSI, Grenoble cedex 09 (FR); Maude BERT, Grenoble cedex 09 (FR); Jérôme DECHAMP, Grenoble cedex 09 (FR)

(73) Assignee: Commissariat à l'Energie Atomique et aux Energies Alternatives, Paris (FR)

(21) Appl. No.: 18/489,908

(22) Filed: Oct. 19, 2023

(30) Foreign Application Priority Data
Oct. 20, 2022 (FR) 22 10878

(51) Int. Cl. H01M 4/525; H01M 10/0525; H01M 10/0562; H01M 10/0585

(52) U.S. Cl. CPC H01M 4/525; H01M 10/0525; H01M 10/0562; H01M 10/0585; H01M 2004/021

(57) ABSTRACT

A solid-state microbattery, including a substrate; a lithium-cobalt-oxide layer forming a cathode having first and second opposite surfaces; a lithium-based solid-state electrolyte formed on the first surface of the cathode; the second surface of the cathode is oriented towards the substrate; an anode formed on the solid-state electrolyte; noteworthy in that the lithium-cobalt-oxide layer possesses a grain size that increases from the first surface to the second surface.

### TECHNICAL FIELD

The invention relates to the technical field of solid-state microbatteries comprising a lithium-based solid-state electrolyte.

The invention is notably applicable to microelectronics, the internet of things, and implantable or portable devices.

### PRIOR ART

A process for manufacturing a solid-state microbattery known in the prior art, and notably from document US 2021/0359339 A1, comprises steps of:
a) forming a lithium-cobalt-oxide cathode using a film deposition technique;
b) polishing the surface of the cathode;
c) reactivating the surface of the cathode using an oxygen-plasma treatment.

Using a thick lithium-cobalt-oxide layer (i.e. having a thickness of several tens of microns) results in a high surface roughness and leads to high leakage currents. Steps B) and C) allow this problem to be solved.

However, such a prior-art process is not entirely satisfactory insofar as steps B) and C) may be tricky to implement. Steps B) and C) require dedicated equipment (e.g. a vacuum chamber for the plasma, see § 0038) and result in certain difficulties (e.g. polishing adds a layer of contaminants to the surface of the cathode, see § 0071). Steps B) and C) may require a long time to implement and specific skills may be required to optimize adjustable parameters (e.g. gas to be used, plasma processing time, plasma density, removal of the layer of contaminants, etc.).

People of skill in the art have therefore been researching a way of avoiding steps B) and C) while nonetheless limiting leakage currents.

### SUMMARY OF THE INVENTION

The invention aims to completely or partially remedy the aforementioned drawbacks. To this end, one subject of the invention is a process for manufacturing a solid-state microbattery, comprising successive steps of:
a) using a stack comprising, in succession, an initial substrate and a lithium-cobalt-oxide layer; the lithium-cobalt-oxide layer forms a cathode having first and second opposite surfaces, the first surface being oriented towards the initial substrate; the lithium-cobalt-oxide layer possesses a grain size that increases from the first surface to the second surface;
b) joining a transfer substrate to the second surface of the cathode then flipping the stack;
c) removing the initial substrate so as to expose the first surface of the cathode;
d) forming a lithium-based solid-state electrolyte on the first surface of the cathode;
e) forming an anode on the solid-state electrolyte.

Thus, such a process according to the invention allows, notably by virtue of step b), a favourable crystallography (i.e. smaller grains) to be obtained at the interface between the first surface of the cathode and the electrolyte, while avoiding steps B) and C) of the prior art. The inventors have found that growth of a lithium-cobalt-oxide layer on an initial substrate produces a grain size that increases from the first surface (which is oriented towards the initial substrate) to the opposite second surface, the first surface having a low roughness and the second surface having a high roughness. Steps b) and c) make it possible to obtain the presence of small grains at the interface between the first surface of the cathode and the electrolyte, and thereby to limit leakage currents.

Moreover, the presence of small grains at the interface between the first surface of the cathode and the electrolyte subsequently facilitates diffusion of Li⁺ lithium ions, this allowing the internal resistance of the microbattery to be decreased.

The process according to the invention may comprise one or more of the following features.

According to one feature of the invention, step a) is executed such that the lithium-cobalt-oxide layer is a polycrystalline layer.

A polycrystalline layer differs from a layer made up of an agglomerate of grains. Thus, it is possible with a polycrystalline lithium-cobalt-oxide layer to obtain a higher available energy per unit volume compared to a layer made up of agglomerated grains.

According to one feature of the invention, step a) is executed such that:
the lithium-cobalt-oxide layer contains, in succession, first and second zones oriented towards the first and second surfaces, respectively;
the first zone predominantly contains equiaxed grains;
the second zone predominantly contains columnar grains.

As mentioned above, the inventors have found that growth of a lithium-cobalt-oxide layer on an initial substrate produces a grain size that increases from the first zone to the second zone, the first surface having a low roughness (equiaxed grains) and the second surface having a high roughness (columnar grains).

According to one feature of the invention, step a) is executed such that the first zone has a thickness comprised between 100 nm and 500 nm, and preferably comprised between 200 nm and 400 nm.

One advantage of such a thickness is that it subsequently facilitates diffusion of Li⁺ lithium ions, this allowing the internal resistance of the microbattery to be decreased.

According to one feature of the invention, step a) is executed such that the first zone possesses an average grain size less than or equal to 40 nm.

One advantage of such a grain size is that it significantly limits leakage currents.

According to one feature of the invention, step a) is executed such that the lithium-cobalt-oxide layer has a thickness comprised between 1 μm and 200 μm, and preferably comprised between 10 μm and 200 μm.

One advantage of such a thickness is that it increases the storage capacity of the microbattery.

According to one feature of the invention, step a) is executed such that the stack comprises a cathode current collector formed on the second surface of the lithium-cobalt-oxide layer; and step b) is executed such that the transfer substrate is joined to the cathode current collector.

Depending on the materials of the transfer substrate and of the cathode current collector, it may be judicious to form the cathode current collector on the second surface of the lithium-cobalt-oxide layer to facilitate joining in step b).

According to one feature of the invention, step b) is executed such that the transfer substrate comprises a cathode current collector joined to the second surface of the cathode.

Depending on the materials of the transfer substrate and of the cathode current collector, it may be judicious to form the cathode current collector on the transfer substrate beforehand, to facilitate joining in step b).

According to one feature of the invention, step b) is executed such that the transfer substrate is made of an electrically conductive material such that the transfer substrate forms a cathode current collector.

One advantage thereof is to avoid the need to form a dedicated layer for performing the function of cathode current collector.

According to one feature of the invention, step a) is executed such that the stack comprises a buffer layer, preferably a metal buffer layer, formed between the initial substrate and the lithium-cobalt-oxide layer; and step c) consists in removing the initial substrate and the buffer layer so as to expose the first surface of the cathode.

One advantage of the buffer layer is that it ensures the stack exhibits a good mechanical strength, for example when the initial substrate and the lithium-cobalt-oxide layer have substantially different coefficients of thermal expansion. Moreover, the buffer layer may perform a stop-layer function during removal of the initial substrate in step c), which may for example be achieved by grinding.

According to one feature of the invention, the method comprises a step f) of forming an anode current collector electrically connected to the anode, step f) being executed after step e).

The anode current collector may be formed on the anode. However, the anode current collector may be formed on the transfer substrate, so as to be electrically connected to the anode and electrically insulated from the cathode.

According to one feature of the invention, step a) comprises steps of:
a₁) using the initial substrate;
a₂) forming the lithium-cobalt-oxide layer on the initial substrate by growth configured so that the lithium-cobalt-oxide layer possesses a grain size that increases from the first surface to the second surface;
step a2) being executed such that the lithium-cobalt-oxide layer is formed on the buffer layer when a buffer layer is present;
step a2) being executed using a technique chosen from electrolysis, cathode sputtering, and chemical vapour deposition.

As mentioned above, the inventors have found that growth of a lithium-cobalt-oxide layer on an initial substrate produces a grain size that increases from the first surface (which is oriented towards the initial substrate) to the opposite second surface, the first surface having a low roughness and the second surface having a high roughness.

Another subject of the invention is a solid-state microbattery comprising:
a substrate;
a lithium-cobalt-oxide layer forming a cathode having first and second opposite surfaces;
a lithium-based solid-state electrolyte formed on the first surface of the cathode; the second surface of the cathode is oriented towards the substrate;
an anode formed on the solid-state electrolyte;
characterized in that the lithium-cobalt-oxide layer possesses a grain size that increases from the first surface to the second surface.

Thus, such a microbattery according to the invention possesses small grains at the interface between the first surface of the cathode and the electrolyte, this allowing leakage currents to be limited. Moreover, the presence of small grains at the interface between the first surface of the cathode and the electrolyte subsequently facilitates diffusion of Li⁺ lithium ions, this allowing the internal resistance of the microbattery to be decreased.

According to one feature of the invention, the lithium-cobalt-oxide layer is a polycrystalline layer.

A polycrystalline layer differs from a layer made up of an agglomerate of grains. Thus, it is possible with a polycrystalline lithium-cobalt-oxide layer to obtain a higher available energy per unit volume compared to a layer made up of agglomerated grains.

According to one feature of the invention:
the lithium-cobalt-oxide layer contains, in succession, first and second zones oriented towards the first and second surfaces, respectively;
the first zone predominantly contains equiaxed grains;
the second zone predominantly contains columnar grains.

Thus, the first surface has a low roughness (equiaxed grains) while the second surface has a high roughness (columnar grains).

According to one feature of the invention, the first zone possesses an average grain size less than or equal to 40 nm.

One advantage of such a grain size is that it significantly limits leakage currents.

According to one feature of the invention:
the lithium-cobalt-oxide layer has a thickness comprised between 1 μm and 200 μm, and preferably comprised between 10 μm and 200 μm;
the first zone has a thickness comprised between 100 nm and 500 nm, and preferably comprised between 200 nm and 400 nm.

One advantage of such a thickness of the lithium-cobalt-oxide layer is that it increases the storage capacity of the microbattery. Furthermore, one advantage of such a thickness of the first zone is that it subsequently facilitates diffusion of Li⁺ lithium ions, this allowing the internal resistance of the microbattery to be decreased.

### Definitions

By “microbattery”, what is meant is a so-called “all-solid-state” accumulator comprising a stack formed from thin solid layers, the stack generally having a thickness of the order of about ten microns or of about one hundred microns. More precisely, a microbattery may be defined as a battery having the following features:
   (i) all active layers (i.e. the electrodes and the electrolyte) are made solely of a solid inorganic material, this therefore notably excluding liquid electrolytes or electrolytes made of a polymer in gel form, and electrodes made of a material containing polymer-based binders;
   (ii) the individual thickness of the active layers is smaller than 500 μm, and the thickness of the electrolyte is generally smaller than 5 μm;
   (iii) areal dimensions typically range from 1 mm² to 10 cm².
By “substrate”, what is meant is a self-supporting physical carrier. A substrate may be a wafer, which generally takes the form of a disc obtained by cutting an ingot of a crystalline material.
By “grain size”, what is meant is a characteristic dimension of the lithium-cobalt-oxide particles (grains), which may be obtained via granulometric analysis (e.g. using transmission-electron micrographs). The grain size may correspond to an equivalent diameter, i.e. to the diameter of the sphere that would have a behaviour identical or equivalent to a given lithium-cobalt-oxide particle.
By “average grain size”, what is meant is an arithmetic mean of the characteristic dimensions of the lithium-cobalt-oxide particles.
By “predominantly”, what is meant is that more than 50% of the grains in the first zone are equiaxed. In the same way, what is meant is that more than 50% of the grains in the second zone are columnar.
By “-based”, what is meant is that lithium is a constituent element of the solid-state electrolyte. Lithium is not necessarily the main and predominant element of the solid-state electrolyte. The solid-state electrolyte may comprise lithium Li, phosphorus P and oxygen O, optionally with nitrogen N and/or sulphur S. Oxygen O may be the predominant component of the solid-state electrolyte.
By “equiaxed grains”, what is meant is grains exhibiting growth that lacks a privileged crystal orientation (isotropic growth).
By “columnar grains”, what is meant is grains of elongate shape (also called dendrites) exhibiting growth that possesses a privileged crystal orientation (anisotropic growth).
By “thickness”, what is meant is a heightwise dimension of the stack, i.e. a dimension measured normal to the surface of the initial substrate.
By “electrically conductive”, what is meant is that the material of the transfer substrate has an electrical conductivity at 300 K higher than or equal to 10² S/cm.
values X and Y, expressed using the expressions “between X and Y” or “comprised between X and Y” are included in the defined range of values.

### BRIEF DESCRIPTION OF THE DRAWINGS

Other features and advantages will become apparent from the detailed description of various embodiments of the invention, the description containing examples and references to the appended drawings.

FIG. 1 shows schematic cross-sectional views representing steps of a process according to the invention, and illustrating an embodiment in which the transfer substrate forms a cathode current collector.

FIG. 2 shows schematic views analogous to FIG. 1, further illustrating an example of execution of step f).

FIG. 3 shows schematic views analogous to FIG. 1, further illustrating the presence of a buffer layer.

FIG. 4 shows schematic views analogous to FIG. 3, further illustrating the presence of an oxide layer coating the initial substrate, and on which the buffer layer is formed.

FIG. 5 shows schematic cross-sectional views representing steps of a process according to the invention, and illustrating an embodiment in which a cathode current collector is formed on the second surface of the lithium-cobalt-oxide layer.

FIG. 6 shows schematic cross-sectional views representing steps of a process according to the invention, and illustrating an embodiment in which the transfer substrate forms a cathode current collector.

FIG. 7 shows schematic cross-sectional views representing steps of a process according to the invention, and illustrating an embodiment in which a buffer layer and an oxide layer that coats the initial substrate are present, the buffer layer being formed on the oxide layer, and in which a cathode current collector is formed on the second surface of the lithium-cobalt-oxide layer.

FIG. 8 is a schematic cross-sectional view partially showing (e.g. the anode current collector is not illustrated) a microbattery according to the invention.

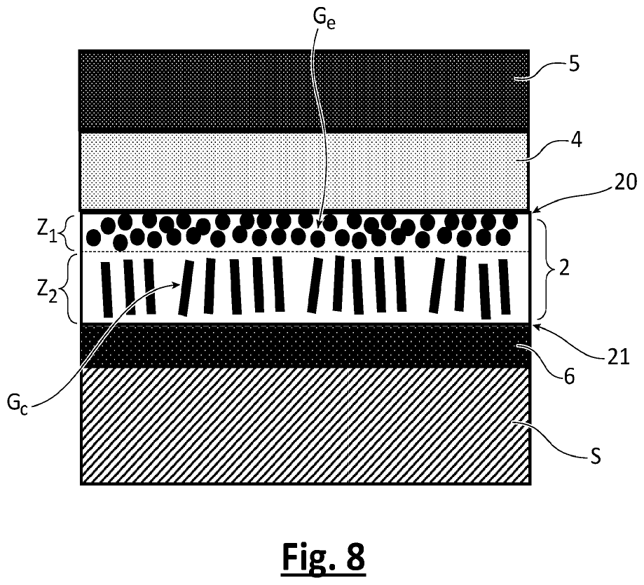

It should be noted that, for the sake of legibility and ease of understanding, the drawings described above are schematic, and not necessarily to scale. The cross sections are cross sections cut heightwise through the stack, or in other words normal to the surface of the initial substrate.

### DETAILED DESCRIPTION OF EMBODIMENTS

For the sake of simplicity, elements that are identical or that perform the same function in the various embodiments have been designated with the same references.

### Process

One subject of the invention is a process for manufacturing a solid-state microbattery, comprising successive steps of:
a) using a stack comprising, in succession, an initial substrate 1 and a lithium-cobalt-oxide layer 2; the lithium-cobalt-oxide layer 2 forms a cathode having first and second opposite surfaces 20, 21, the first surface 20 being oriented towards the initial substrate 1; the lithium-cobalt-oxide layer 2 possesses a grain size that increases from the first surface 20 to the second surface 21;
b) joining a transfer substrate 3 to the second surface 21 of the cathode 2 then flipping the stack;
c) removing the initial substrate 1 so as to expose the first surface 20 of the cathode 2;
d) forming a lithium-based solid-state electrolyte 4 on the first surface 20 of the cathode 2;
e) forming an anode 5 on the solid-state electrolyte 4.

### Step a)

The stack used in step a) comprises, in succession, an initial substrate 1 and a lithium-cobalt-oxide (LiCoO₂) layer 2. The lithium-cobalt-oxide layer 2 has first and second opposite surfaces 20, 21, the first surface 20 being oriented towards the initial substrate 1. The lithium-cobalt-oxide layer 2 possesses a grain size that increases from the first surface 20 to the second surface 21.

Step a) is advantageously executed such that:
the lithium-cobalt-oxide layer 2 contains, in succession, first and second zones Z₁, Z₂ oriented towards the first and second surfaces 20, 21 of the cathode 2, respectively;
the first zone Z₁ predominantly contains equiaxed grains Gₑ;
the second zone Z₂ predominantly contains columnar grains G_{c}.
Step a) is advantageously executed such that the first zone Z₁ has a thickness comprised between 100 nm and 500 nm, and preferably comprised between 200 nm and 400 nm.
Step a) is advantageously executed such that the first zone Z₁ possesses an average grain size less than or equal to 40 nm.
Step a) is advantageously executed such that the lithium-cobalt-oxide layer 2 has a thickness comprised between 1 μm and 200 μm, and preferably comprised between 10 μm and 200 μm.
Step a) is advantageously executed such that the lithium-cobalt-oxide layer 2 is a polycrystalline layer. A polycrystalline layer differs from a layer made up of an agglomerate of grains. Thus, it is possible with a polycrystalline lithium-cobalt-oxide layer to obtain a higher available energy per unit volume compared to a layer made up of agglomerated grains.

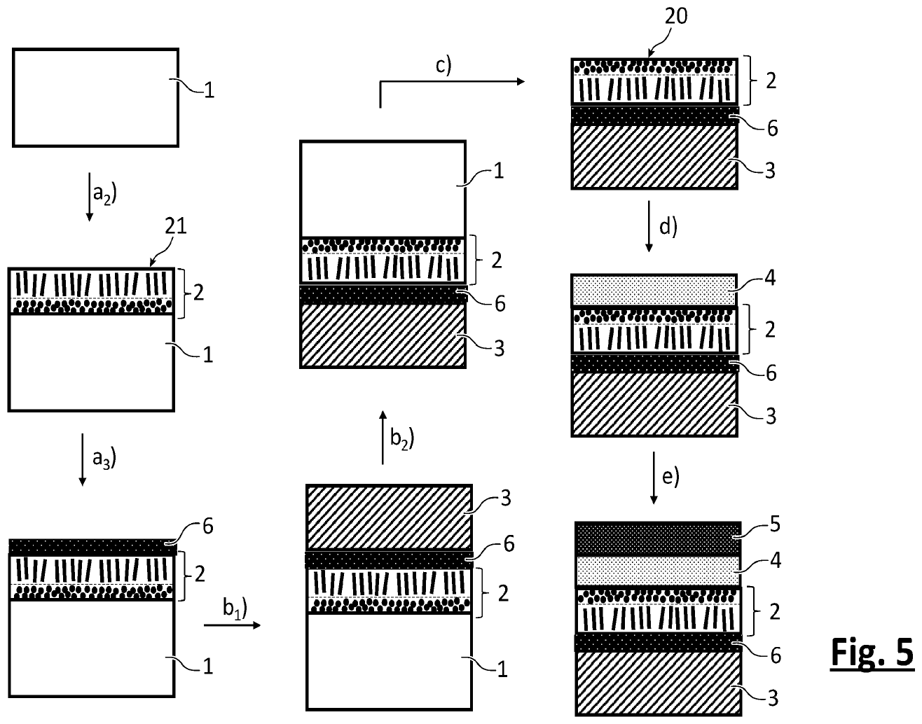

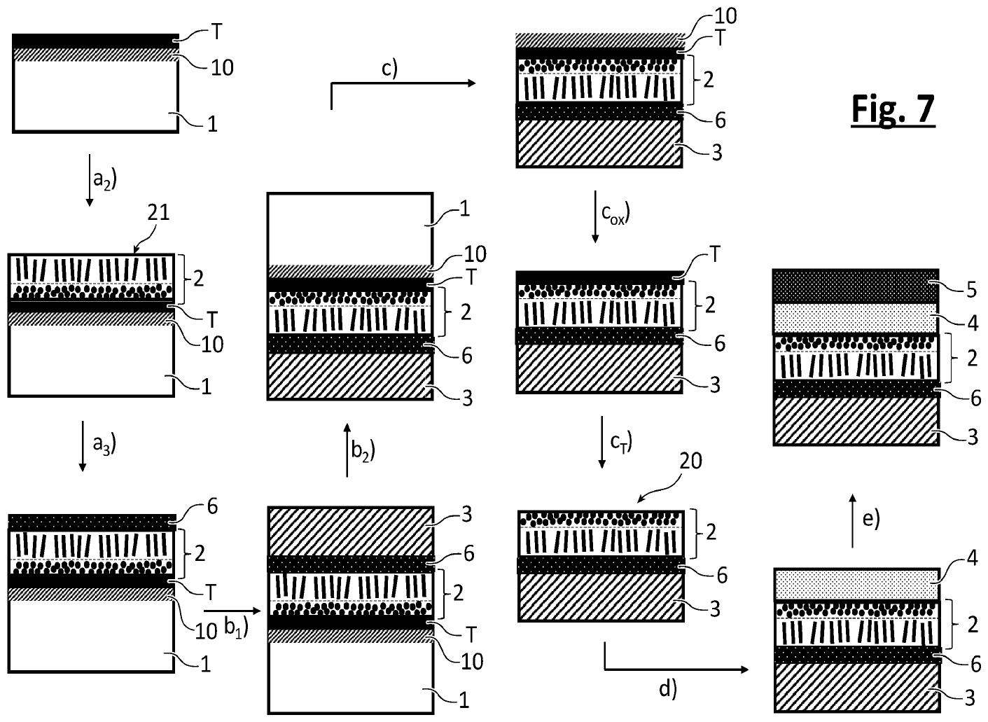

According to an embodiment illustrated in FIGS. 5 and 7, step a) is executed such that the stack comprises a cathode current collector 6 formed on the second surface 21 of the lithium-cobalt-oxide layer 2. By way of non-limiting example, the cathode current collector 6 may be made of a titanium-copper (TiCu) alloy. As a variant, the cathode current collector 6 may comprise a titanium (Ti) layer and a copper (Cu) layer. The titanium layer may have a thickness of 500 nm. The copper layer may have a thickness of 1 μm.

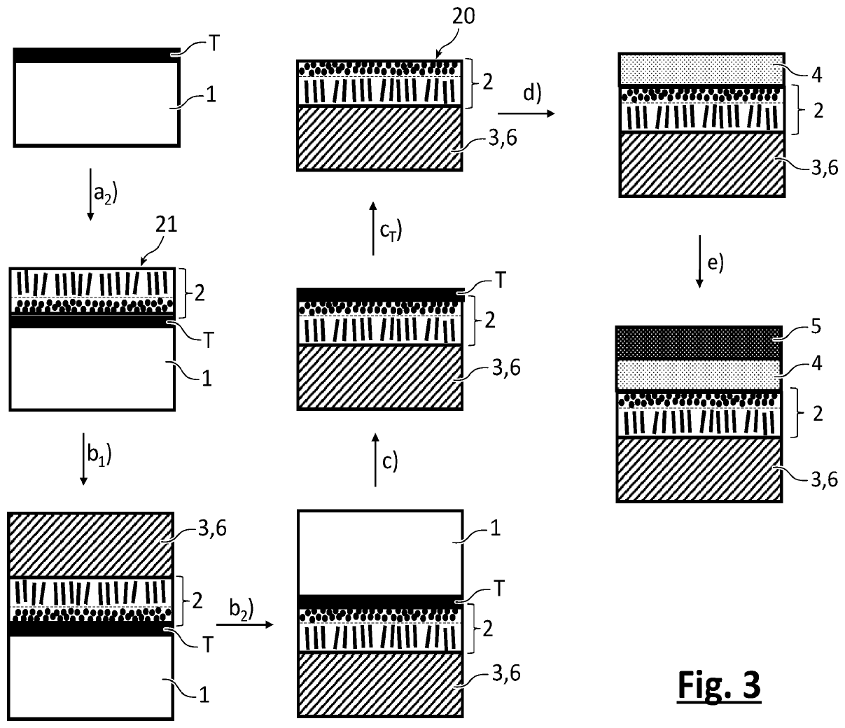

As illustrated in FIGS. 3, 4 and 7, step a) is advantageously executed such that the stack comprises a buffer layer T, preferably a metal buffer layer, formed between the initial substrate 1 and the lithium-cobalt-oxide layer 2. By way of non-limiting examples, the buffer layer T may be made of titanium (Ti) or platinum (Pt).

Step a) advantageously comprises steps of:
a₁) using the initial substrate 1;
a₂) forming the lithium-cobalt-oxide layer 2 on the initial substrate 1 by growth configured so that the lithium-cobalt-oxide layer 2 possesses a grain size that increases from the first surface 20 to the second surface 21.

Step a₂) is executed such that the lithium-cobalt-oxide layer 2 is formed on the buffer layer T where appropriate. Step a₂) is advantageously executed using a technique chosen from electrolysis, cathode sputtering, and chemical vapour deposition.

The electrolysis is a hydrothermal electrochemical process. The precursor bath may be composed of a cobalt salt in a concentrated lithium-hydroxide solution, the solvent possibly being demineralized and deoxygenated water. Temperature may be controlled to between 150° C. and 200° C. The electrolysis conditions may be such as to achieve a constant current density. The lithium-cobalt-oxide layer 2 formed by electrolysis may have a large thickness, up to several hundred μm.

Cathode sputtering is a technique (cold process) in which particles are torn from a cathode (called the “target”, made of lithium-cobalt oxide) and then recondensed on the initial substrate 1 (or on the buffer layer T where appropriate) in a rarefied atmosphere. A cold plasma is created between the target and the initial substrate 1. Under the effect of an electric field, the positive species of the plasma are attracted by the cathode (target) and collide therewith. The positive species of the plasma transmit their momentum and cause atoms from the target to be ejected in the form of neutral particles, which condense on the initial substrate 1. The film is formed via a number of mechanisms, which depend on the forces of interaction between the initial substrate 1 and the film. By way of non-limiting example, in the presence of a platinum buffer layer T formed on the initial substrate 1, the cathode sputtering may be executed at a temperature comprised between 50° C. and 60° C., with a power of 200 W and a bias voltage of the order of −50 V.

Chemical vapour deposition (CVD) is a process in which the initial substrate 1 is exposed to one or more gas-phase precursors that react and/or decompose on the surface of the initial substrate 1 to generate the desired deposit. The precursors used to form the lithium-cobalt oxide may be (cyclopentadienyl)cobalt dicarbonyl (CpCo(CO)₂) and tert-butyllithium (t-BuLi). The CVD may be carried out at a temperature of the order of 500° C.

According to an embodiment illustrated in FIGS. 5 and 7, step a) may comprise a step a₃) consisting in forming a cathode current collector 6 on the second surface 21 of the lithium-cobalt-oxide layer 2. Step a₃) is executed after step a₂).

Step a) is advantageously executed such that the initial substrate 1 is chosen from:
a glass substrate,
a silicon substrate coated with a silicon-dioxide layer 10.

### Step b)

Step b) consists in joining a transfer substrate 3 to the second surface 21 of the cathode then flipping the stack. Step b) comprises steps of:
b₁) joining a transfer substrate 3 to the second surface 21 of the cathode 2;
b₂) flipping the stack such that the stack rests on the transfer substrate 3.

As illustrated in FIGS. 5 and 7, when step a) is executed such that the stack comprises a cathode current collector 6 formed on the second surface 21 of the lithium-cobalt-oxide layer 2, step b) is executed such that the transfer substrate 3 is joined to the cathode current collector 6. More precisely, step b₁) is executed such that the transfer substrate 3 is joined to the cathode current collector 6.

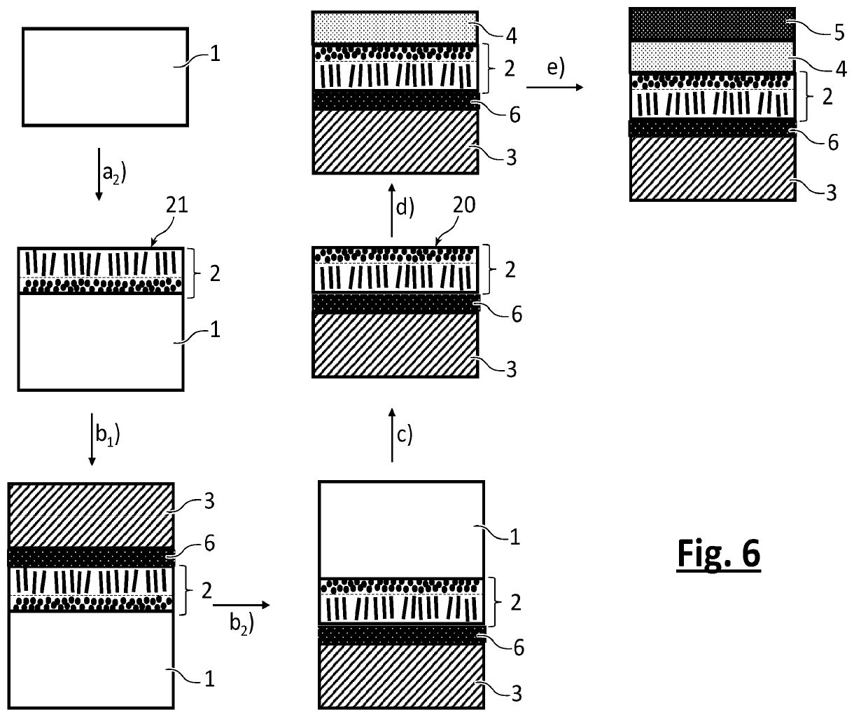

According to a variant of embodiment illustrated in FIG. 6, step b) is executed such that the transfer substrate 3 comprises a cathode current collector 6 joined to the second surface 21 of the cathode 2. In other words, the transfer substrate 3 may be coated with the cathode current collector 6. By way of non-limiting example, the cathode current collector 6 may be made of a titanium-copper (Ti—Cu) alloy or a titanium-gold (Ti—Au) alloy. As a variant, the cathode current collector 6 may comprise a titanium (Ti) layer and a copper (Cu) layer. The titanium layer may have a thickness comprised between 20 nm and 500 nm. The copper layer may have a thickness comprised between 500 nm and 2 μm. As a variant, the cathode current collector 6 may comprise a titanium (Ti) layer and a gold (Au) layer. The titanium layer may have a thickness comprised between 20 nm and 500 nm. The gold layer may have a thickness comprised between 200 nm and 500 nm.

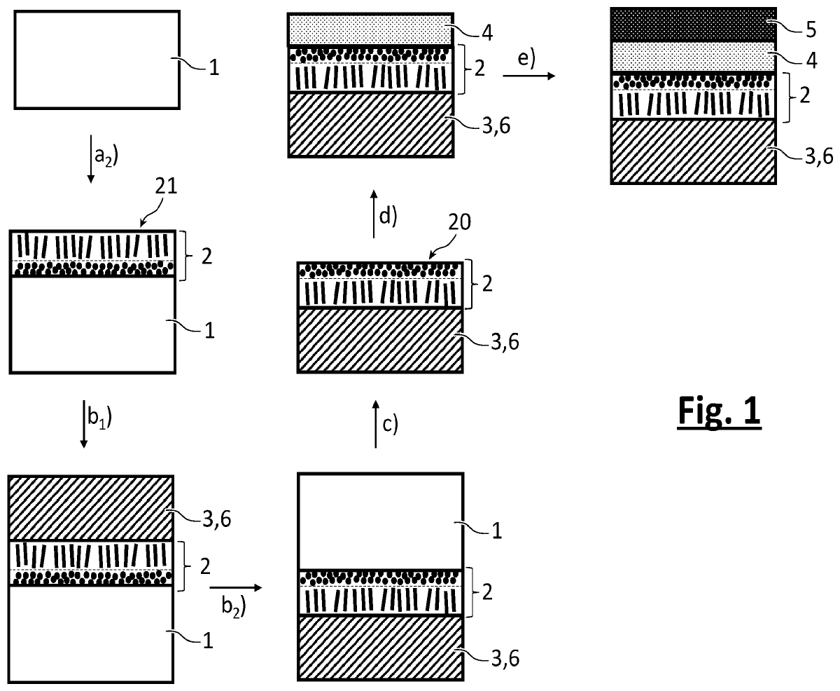

According to another variant of embodiment illustrated in FIGS. 1 to 4, step b) is executed such that the transfer substrate 3 is made of an electrically conductive material such that the transfer substrate 3 forms a cathode current collector 6. By way of non-limiting examples, the electrically conductive material may be a metal (e.g. copper, aluminium) or a polymer such as polyaniline or polyacrylate. Due to the high roughness of the second surface 21 of the cathode 2 and due to the difference in coefficients of thermal expansion between the cathode 2 and the electrically conductive transfer substrate 3, direct bonding cannot generally be used in step b₁) for joining purposes. Thus, it is possible to provide an interface between the second surface 21 of the cathode 2 and the electrically conductive transfer substrate 3. By way of non-limiting examples, it is possible to use as interface:
(i) electrically conductive bumps on the side of the transfer substrate 3, i.e. bumps such as solder bumps (e.g. bumps made of an Sn—Ag alloy with a diameter of at least 100 μm) or gold stud bumps with a diameter of at least 100 μm, the electrically conductive bumps possibly being separated by a polymer such as an electrically non-conductive paste (NCP); and
(ii) a thin (e.g. with a thickness comprised between 20 nm and 100 nm) metal (e.g. one made of Ti—Au alloy) layer on the side of the second surface 21 of the cathode 2.

The metal layer of the interface makes it possible to make the second surface 21 of the cathode 2 wettable. The electrically conductive gold bumps permit joining to be carried out cold or at low temperature (100° C.-150° C.) while solder bumps allow permit joining to be carried out at a temperature of the order of 250° C.

In one embodiment, step b) is executed such that the transfer substrate 3 is made of a cured polymer. When the cured polymer is dielectric (e.g. an epoxy resin, polyimide or polybenzoxazole PBO), the process advantageously comprises a step of forming electrically conductive tracks within the cured polymer, for example by laser drilling.

By way of non-limiting example, the transfer substrate 3 may have a thickness comprised between 200 μm and 1 mm.

By way of non-limiting examples, step b) may be executed using eutectic bonding, brazing, a conductive lacquer (screen-printed type) or by means of an adhesive (e.g. epoxy) depending on the nature of the materials of the transfer substrate 3 and of the cathode current collector 6. Eutectic bonding and brazing require a metal layer (e.g. two Ti/Cu or Ti/Au sub-layers) to be formed on the second surface 21 of the cathode 2.

### Step c)

Step c) consists in removing the initial substrate 1 so as to expose the first surface 20 of the cathode 2.

When step a) is executed such that the stack comprises a buffer layer T, preferably a metal buffer layer, formed between the initial substrate 1 and the lithium-cobalt-oxide layer 2, then step c) consists in removing the initial substrate 1 and the buffer layer T so as to expose the first surface 20 of the cathode 2. In other words, step c) comprises a step c_{T}) consisting in removing the buffer layer T so as to expose the first surface 20 of the cathode 2.

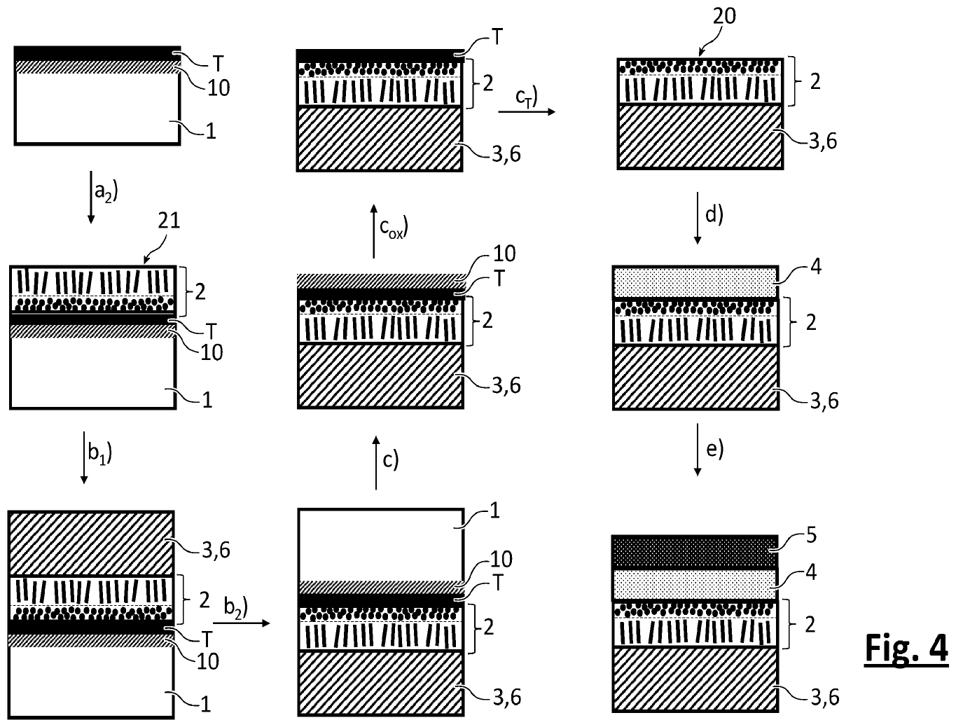

As illustrated in FIGS. 4 and 7, when the initial substrate 1 is a silicon substrate coated with a silicon-dioxide layer 10, the silicon substrate may be removed via a grinding step, followed by a step of (dry or wet) etching of the remaining silicon, the silicon-dioxide layer 10 acting as a stop layer. The silicon substrate is initially thinned by grinding until a thickness of a few tens of μm is reached. The stack may be held by suction against a porous ceramic chuck, then placed under a grinding wheel. The grinding wheel comprises a set of teeth placed on the perimeter of a metal base containing synthetic diamond grains of sizes tailored to the material, a resin binder or the like, and of a controlled porosity. The grinding wheel and the chuck are then rotated and the grinding wheel descends so as to thin the initial substrate 1 until a thickness comprised between 10 μm and 100 μm, and preferably 50 μm, is left. This remaining thickness will then be removed by dry or wet etching to the silicon-dioxide layer 10. The speed of rotation of the grinding wheel (varying in a range from 0 to 3000 rpm), the speed of descent of the grinding wheel (varying in a range from 0.01 to 50 μm/s) and the speed of rotation of the chuck (varying from 0 to 300 rpm) are tailored to the materials and thicknesses to be removed. The grinding may involve a sequence of a plurality of descent speeds and a sequence of a plurality of grinding wheels. By way of non-limiting example, the grinding may be performed using a Disco DAG 810 with a Disco GF01 grinding wheel. The speed of rotation of the grinding wheel may be of the order of 2000 rpm. The descent speed of the grinding wheel may be of the order of 1.5 μm/s. The speed of rotation of the chuck may be of the order of 300 rpm.

Subsequently, the silicon-dioxide layer 10 may be removed by etching—step cₒₓ)—, the buffer layer T acting as a stop layer. Lastly, the buffer layer T may be removed by etching—step c_{T})—, the cathode 2 acting as a stop layer.

### Step d)

Step d) consists in forming a lithium-based solid-state electrolyte 4 on the first surface 20 of the cathode 2.
Step d) is advantageously executed such that the solid-state electrolyte 4 is made of a solid-state ionic conductor, and preferably of lithium phosphorus oxynitride (LiₓPO_{y}N_{z}).

The solid-state electrolyte 4 may have a thickness comprised between 100 nm and 4 μm.

### Step e)

Step e) consists in forming an anode 5 on the solid-state electrolyte 4. The anode 5 is preferably made of a metal chosen from titanium Ti, copper Cu, lithium Li, aluminium Al, platinum Pt, and stainless steel.

The anode 5 may have a thickness comprised between 500 nm and 20 μm.

### Step f)

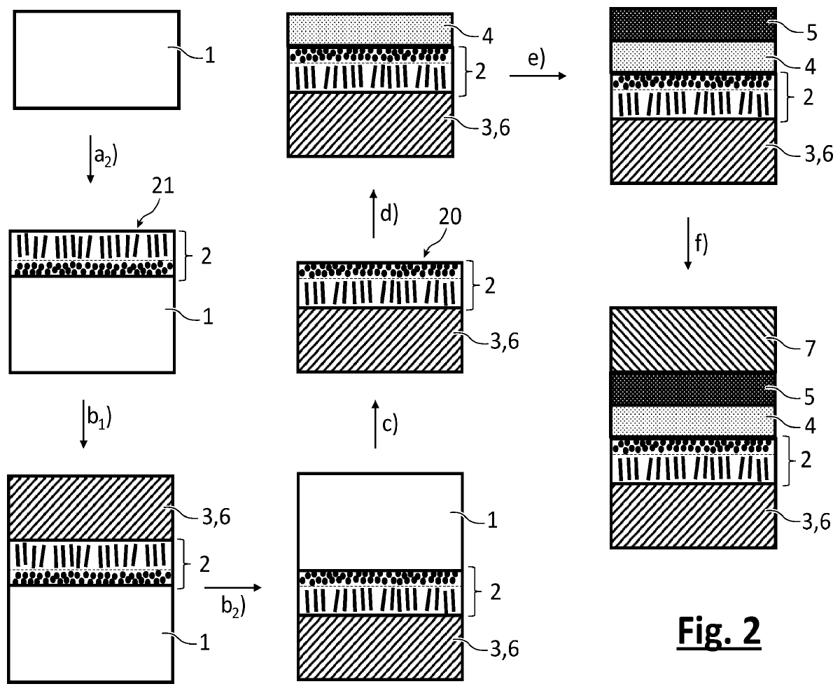

As illustrated in FIG. 2, the process advantageously comprises a step f) consisting in forming an anode current collector 7 electrically connected to the anode 5. The anode current collector 7 may be formed on the anode 5. Step f) is then executed after step e). However, the anode current collector 7 may be formed on the transfer substrate 3, so as to be electrically connected to the anode 5 and electrically insulated from the cathode 2.

By way of non-limiting example, the anode current collector 7 may be made of a titanium-copper (Ti—Cu) alloy or a titanium-gold (Ti—Au) alloy. As a variant, the anode current collector 7 may comprise a titanium (Ti) layer and a copper (Cu) layer. The titanium layer may have a thickness comprised between 20 nm and 500 nm. The copper layer may have a thickness comprised between 500 nm and 2 μm. As a variant, the anode current collector 7 may comprise a titanium (Ti) layer and a gold (Au) layer. The titanium layer may have a thickness comprised between 20 nm and 500 nm. The gold layer may have a thickness comprised between 200 nm and 500 nm.

### Microbattery

One subject of the invention is a solid-state microbattery comprising:
a substrate S;
a lithium-cobalt-oxide layer 2 forming a cathode having first and second opposite surfaces 20, 21;
a lithium-based solid-state electrolyte 4 formed on the first surface 20 of the cathode 2; the second surface 21 of the cathode is oriented towards the substrate S;
an anode 5 formed on the solid-state electrolyte 4;
noteworthy in that the lithium-cobalt-oxide layer 2 possesses a grain size that increases from the first surface 20 to the second surface 21.

### Substrate

By way of non-limiting examples, the substrate S may be made of:
a cured dielectric polymer containing electrically conductive tracks;
a metal;
a semiconductor;
a glass or a ceramic.

The substrate S may be temporary or permanent.

### Cathode

The lithium-cobalt-oxide (LiCoO₂) layer 2 has first and second opposite surfaces 20, 21, the second surface 21 being oriented towards the substrate S. The lithium-cobalt-oxide layer 2 possesses a grain size that increases from the first surface 20 to the second surface 21.

According to one embodiment, the lithium-cobalt-oxide layer 2 contains, in succession, first and second zones Z₁, Z₂ oriented towards the first and second surfaces 20, 21 of the cathode 2, respectively. The first zone Z₁ predominantly contains equiaxed grains Gₑ. The second zone Z₂ predominantly contains columnar grains G_{c}.

The first zone Z₁ advantageously possesses an average grain size of less than or equal to 40 nm. The first zone Z₁ advantageously has a thickness comprised between 100 nm and 500 nm, and preferably comprised between 200 nm and 400 nm.

The lithium-cobalt-oxide layer 2 advantageously has a thickness comprised between 1 μm and 200 μm, and preferably comprised between 10 μm and 200 μm.

The lithium-cobalt-oxide layer 2 is advantageously a polycrystalline layer. A polycrystalline layer differs from a layer made up of an agglomerate of grains. Thus, it is possible with a polycrystalline lithium-cobalt-oxide layer to obtain a higher available energy per unit volume compared to a layer made up of agglomerated grains.

### Solid-State Electrolyte

The solid-state electrolyte 4 is lithium-based. The solid-state electrolyte 4 is formed on the first surface 20 of the cathode 2.

The solid-state electrolyte 4 is advantageously made of a solid-state ionic conductor, and preferably of lithium phosphorus oxynitride (LiₓPO_{y}N_{z}).

The solid-state electrolyte 4 may have a thickness comprised between 100 nm and 4 μm.

### Anode

The anode 5 is formed on the solid-state electrolyte 4.

The anode 5 is preferably made of a metal chosen from titanium Ti, copper Cu, lithium Li, aluminium Al, platinum Pt, and stainless steel.

The anode 5 may have a thickness comprised between 500 nm and 20 μm.

### Current Collectors

The microbattery may comprise a cathode current collector 6 electrically connected to the cathode 2. The cathode current collector 6 may consist of the substrate S. As a variant, the cathode current collector 6 may be formed between the substrate S and the cathode 2. By way of non-limiting example, the cathode current collector 6 may be made of a titanium-copper (Ti—Cu) alloy or a titanium-gold (Ti—Au) alloy. As a variant, the cathode current collector 6 may comprise a titanium (Ti) layer and a copper (Cu) layer. The titanium layer may have a thickness comprised between 20 nm and 500 nm. The copper layer may have a thickness comprised between 500 nm and 2 μm. As a variant, the cathode current collector 6 may comprise a titanium (Ti) layer and a gold (Au) layer. The titanium layer may have a thickness comprised between 20 nm and 500 nm. The gold layer may have a thickness comprised between 200 nm and 500 nm.

The microbattery may comprise an anode current collector 7 electrically connected to the anode 5. The anode current collector 7 may be formed on the anode 5. However, the anode current collector 7 may be formed on the substrate S so as to be electrically connected to the anode 5 and electrically insulated from the cathode 2. By way of non-limiting example, the anode current collector 7 may be made of a titanium-copper (Ti—Cu) alloy or a titanium-gold (Ti—Au) alloy. As a variant, the anode current collector 7 may comprise a titanium (Ti) layer and a copper (Cu) layer. The titanium layer may have a thickness comprised between 20 nm and 500 nm. The copper layer may have a thickness comprised between 500 nm and 2 μm. As a variant, the anode current collector 7 may comprise a titanium (Ti) layer and a gold (Au) layer. The titanium layer may have a thickness comprised between 20 nm and 500 nm. The gold layer may have a thickness comprised between 200 nm and 500 nm.

The invention is not limited to the disclosed embodiments. Anyone skilled in the art will be able to consider the technically workable combinations thereof, and to substitute equivalents therefor.

1. A process for manufacturing a solid-state microbattery, comprising successive steps of:
a) using a stack comprising, in succession, an initial substrate and a lithium-cobalt-oxide layer; the lithium-cobalt-oxide layer forms a cathode having first and second opposite surfaces, the first surface being oriented towards the initial substrate; the lithium-cobalt-oxide layer possesses a grain size that increases from the first surface to the second surface; the lithium-cobalt-oxide layer contains, in succession, first and second zones oriented towards the first and second surfaces, respectively; the first zone predominantly contains equiaxed grains, the second zone predominantly contains columnar grains; the first zone possesses an average grain size less than or equal to 40 nm, grain size being a characteristic dimension of the lithium-cobalt-oxide particles that is obtained via granulometric analysis;
b) joining a transfer substrate to the second surface of the cathode then flipping the stack;
c) removing the initial substrate so as to expose the first surface of the cathode;
d) forming a lithium-based solid-state electrolyte on the first surface of the cathode;
(e) forming an anode on the solid-state electrolyte.

2. The process according to claim 1, wherein step a) is executed such that the lithium-cobalt-oxide layer is a polycrystalline layer.

3. The process according to claim 1, wherein step a) is executed such that the first zone has a thickness comprised between 100 nm and 500 nm.

4. The process according to claim 1, wherein step a) is executed such that the lithium-cobalt-oxide layer has a thickness comprised between 1 μm and 200 μm.

5. The process according to claim 1, wherein step a) is executed such that the stack comprises a cathode current collector formed on the second surface of the lithium-cobalt-oxide layer; and step b) is executed such that the transfer substrate is joined to the cathode current collector.

6. The process according to claim 1, wherein step b) is executed such that the transfer substrate comprises a cathode current collector joined to the second surface of the cathode.

7. The process according to claim 1, wherein step b) is executed such that the transfer substrate is made of an electrically conductive material such that the transfer substrate forms a cathode current collector.

8. The process according to claim 1, wherein step a) is executed such that the stack comprises a buffer layer, formed between the initial substrate and the lithium-cobalt-oxide layer; and step c) consists in removing the initial substrate and the buffer layer so as to expose the first surface of the cathode.

9. The process according to claim 1, comprising a step f) of forming an anode current collector electrically connected to the anode, step f) being executed after step e).

10. The process according to claim 1, wherein step a) comprises steps of:
a1) using the initial substrate;
a2) forming the lithium-cobalt-oxide layer on the initial substrate by growth configured so that the lithium-cobalt-oxide layer possesses a grain size that increases from the first surface to the second surface;
step a2) being executed such that the lithium-cobalt-oxide layer is formed on the buffer layer;
step a2) being executed using a technique chosen from electrolysis, cathode sputtering, and chemical vapour deposition.

11. A solid-state microbattery, comprising:
a substrate;
a lithium-cobalt-oxide layer forming a cathode having first and second opposite surfaces; the lithium-cobalt-oxide layer contains, in succession, first and second zones oriented towards the first and second surfaces, respectively; the first zone predominantly contains equiaxed grains; the second zone predominantly contains columnar grains; the first zone possesses an average grain size less than or equal to 40 nm, grain size being a characteristic dimension of the lithium-cobalt-oxide particles that is obtained via granulometric analysis;
a lithium-based solid-state electrolyte formed on the first surface of the cathode; the second surface of the cathode is oriented towards the substrate;
an anode formed on the solid-state electrolyte;
wherein the lithium-cobalt-oxide layer possesses a grain size that increases from the first surface to the second surface.

12. The microbattery according to claim 11, wherein the lithium-cobalt-oxide layer is a polycrystalline layer.

13. The microbattery according to claim 11, wherein:
the lithium-cobalt-oxide layer has a thickness comprised between 1 μm and 200 μm;
the first zone has a thickness comprised between 100 nm and 500 nm.
